(19) United States
(12) Patent Application Publication
(10) Pub. No.: US 2015/0102222 A1
(43) Pub. Date: Apr. 16, 2015

(54) PHOTOMIXER FOR GENERATING AND DETECTING TERAHERTZ CONTINUOUS WAVE AND METHOD OF MANUFACTURING THE SAME

(71) Applicant: Electronics and Telecommunications Research Institute, Daejeon (KR)

(72) Inventors: Nam Je KIM, Daejeon (KR); Kyung Hyun PARK, Daejeon (KR); Sang Pil HAN, Daejeon (KR); Ki Won MOON, Pohang-si (KR); Il Min LEE, Daejeon (KR); Hyun Sung KO, Seoul (KR)

(73) Assignee: Electronics and Telecommunications Research Institute, Daejeon (KR)

(21) Appl. No.: 14/481,287

(22) Filed: Sep. 9, 2014

(30) Foreign Application Priority Data
Oct. 14, 2013 (KR) 10-2013-0122117
Feb. 25, 2014 (KR) 10-2014-0021915

(51) Int. Cl. G01J 1/42; G21K 5/02

(52) U.S. Cl. CPC G01J 1/42; G21K 5/02
USPC 250/338.1; 29/601

(57) ABSTRACT

Disclosed is a photomixer for generating and detecting a terahertz continuous wave, including: an optical conductor to which beating light is incident; and a plurality of antenna feeding electrodes formed on both side surfaces of the optical conductor, and configured to receive a current of a terahertz frequency.

### CROSS-REFERENCE TO RELATED APPLICATIONS

This application claims the benefit of priority under 35 U.S.C. §119(a) of Korean Patent Application Nos. 10-2013-0122117, filed on Oct. 14, 2013 and 10-2014-0021915, filed on Feb. 25, 2014, in the Korean Intellectual Property Office, the entire disclosure of which is incorporated herein by reference for all purposes.

### BACKGROUND

1. Field

The present invention relates to a photomixer for generating and detecting a terahertz continuous wave, and more particularly, to a photomixer, in which a plurality of antenna feeding electrodes are formed on both side surfaces of an optical conductor and is vertically formed with respect to a substrate, thereby securing an uniform inside electric field, and effectively removing heat generated by the optical conductor, and a method of manufacturing the same.

2. Discussion of Related Art

Terahertz (THz) waves having a frequency of 0.1 THz to 10 THz have new characteristics that the THz waves have low energy to be harmless to a human body, and many molecules have inherent spectrums in the frequency band, so that research on the THz waves has been actively conducted recently.

In the research until now, a Time-Domain Spectroscopy (TDS) system using a femtosecond (fs) laser is mainly used. The TDS system adopts a method of exciting a carrier on a photoconductive switch by using the femtosecond laser. Here, the photoconductive switch is formed of a material having a very short carrier lifetime, and serves to flow a pulse type current of a femtosecond level by using the material. Accordingly, the pulse type current flows in an integrated antenna by the photoconductive switch, and thus THz waves of a broad band are generated to be transmitted to the air. As a result, the TDS system adopts a method basically using pulse type THz waves.

However, the fs-laser has a disadvantage in a large size and a high price. Further, in the case of many application fields used in a field, a system, which is small, is portable, and is capable of obtaining a result in a frequency band using THz continuous waves (CW THz), not the TDS, is useful.

Accordingly, a photomixing method of using a photomixer and a laser having two different wavelengths has been researched much for application in the field, and implementation of the micro-miniaturized system.

The photomixing method is a method of basically using beating light created by two different laser light. Particularly, the photomixing method is a method of generating beating light of a THz frequency with laser light having two different wavelengths, generating an AC current of a THz frequency in the photomixer by using the generated beating light, and making an antenna integrated in the photomixer radiate the THz wave. The frequency of the THz wave generated by the photomixing method is the same as the frequency of the beating light, and as a result, is the same as a difference between the wavelengths of the two lasers. Accordingly, it is possible to fabricate a frequency tunable THz wave generator by adjusting one of the two laser wavelengths through the photomixing method.

In the meantime, a currently used photomixer mainly utilize a low-temperature grown semiconductor (optical conductor) having a very short carrier lifetime, and is formed in a form of feeding the antenna through an interdigitated finger structure formed on an “upper surface” of the low-temperature grown semiconductor as illustrated in FIG. 1.

However, the photomixer structure has a problem in that an operation of the photomixer is limited to a region of the upper surface of the low-temperature grown semiconductor, and an uniform electric field is not formed in an entire region, so that speeds of carriers are different from each other according to a region. Further, the low-temperature grown semiconductor is formed of a material having a short carrier lifetime, so that the large amount of heat is generated, but the low-temperature grown semiconductor may not effectively remove the heat, thereby degrading efficiency.

Accordingly, development of a new photomixer capable of solving the problem of the photomixer in the related art has been demanded.

### SUMMARY

The present invention has been made in an effort to provide a photomixer capable of forming a uniform electric field on an entire region, and effectively removing heat generated in an optical conductor.

In the meantime, technical objects to be achieved by the present invention are not limited to the aforementioned objects, and may include various technical objects within the scope apparent to those skilled in the art from the contents to be described below.

An exemplary embodiment of the present invention provides a photomixer for generating and detecting a terahertz continuous wave, including: an optical conductor to which beating light is incident; and a plurality of antenna feeding electrodes formed on both side surfaces of the optical conductor, and configured to receive a current of a terahertz frequency.

Further, the optical conductor may be a low temperature grown semiconductor layer formed on a substrate.

The low temperature grown semiconductor layer may have a width between both side surfaces of 1 μm or smaller.

The beating light may be incident to the low temperature grown semiconductor layer through a waveguide structure.

The plurality of antenna feeding electrodes may be formed in a form that is vertical to the substrate.

A uniform electric field may be formed inside the optical conductor.

Anther exemplary embodiment of the present invention provides a method of manufacturing a photomixer for generating and detecting a terahertz continuous wave, including: forming an optical conductor layer, to which terahertz beating light is incident, on a substrate; and forming a plurality of antenna feeding electrodes, which receives a current of a terahertz frequency, on both side surfaces of the optical conductor.

Further, the method may further include: after the forming of the optical conductor layer, to which the terahertz beating light is incident, etching the optical conductor layer; and forming a waveguide layer for incidence of the beating light by a re-growing process after the optical conductor layer is etched.

Further, in the forming of the plurality of antenna feeding electrodes, which receives the current of the terahertz frequency, the plurality of antenna feeding electrodes may be formed in a form that is vertical to the substrate.

The photomixer according to the present invention may form a uniform and intensive electric field inside the photomixer. Particularly, in the photomixer according to the present invention, the plurality of antenna feeding electrodes, which is formed in a form vertical to the substrate, is formed on both side surfaces of the optical conductor having a small width (preferably, 1 μm or smaller), thereby forming a uniform and intensive electric field in an entire region inside the photomixer. Accordingly, speeds of carriers in the entire region inside the photomixer may be uniform.

Further, the photomixer according to the present invention may effectively remove heat generated by the optical conductor. Particularly, unlike the related art, the photomixer according to the present invention may generate heat throughout the entire region of the optical conductor (heat is concentrated in an upper side surface region of the optical conductor in the related art), and discharge heat through both side surfaces, on which the plurality of antenna feeding electrodes is disposed, thereby effectively removing heat generated by the optical conductor.

Further, the photomixer according to the present invention may efficiently make beating light be incident even in a state where the plurality of antenna feeding electrodes is formed on both side surfaces of the optical conductor, and both side surfaces of the optical conductor are formed to have a small width. Particularly, the photomixer according to the present invention may make beating light be incident in a direction of the side surface by using the waveguide structure formed through a re-growing process, thereby efficiently making the beating light be incident even in a state where an incident area is limited.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a diagram illustrating an example of a structure of a photomixer in the related art;

FIG. 2 is a diagram schematically illustrating a photomixer according to an exemplary embodiment of the present invention;

FIG. 3 is a conceptual diagram illustrating a distribution of an electric field inside the photomixer according to the exemplary embodiment of the present invention; and

FIG. 4 is a top plane view illustrating the photomixer according to the exemplary embodiment of the present invention.

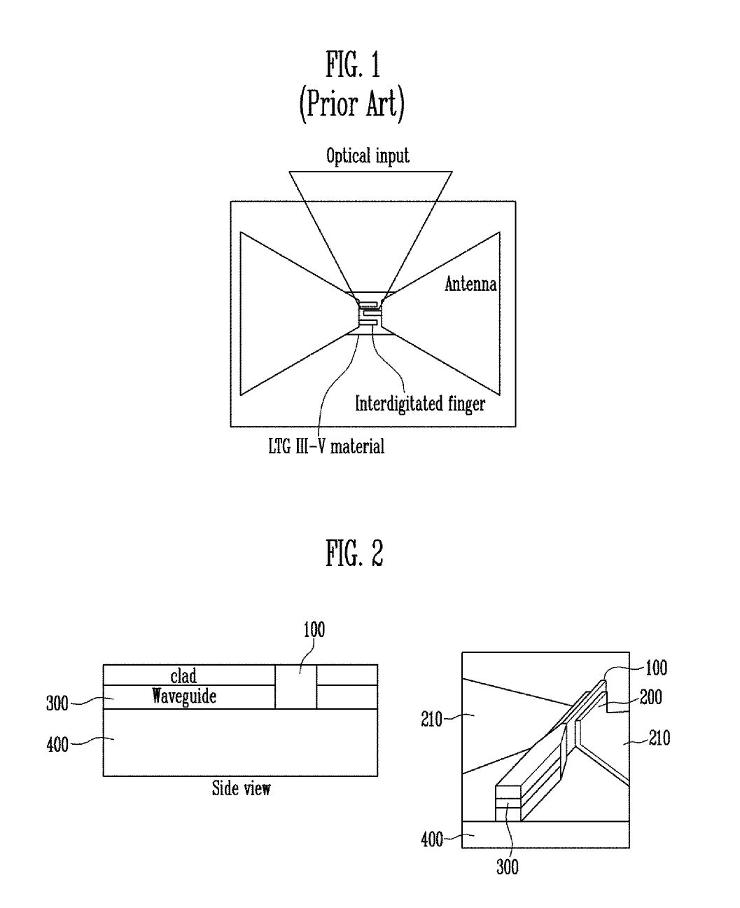

### DETAILED DESCRIPTION

Hereinafter, a photomixer for generating and detecting a terahertz continuous wave, and a method of manufacturing the same according to the present invention will be described with reference to the accompanying drawings. Described exemplary embodiments are provided so that those skilled in the art may easily understand the technical spirit of the present invention, so that the present invention is not limited by the exemplary embodiments. Further, matters in the accompanying drawings are illustrated for easily describing the exemplary embodiments of the present invention, and may be different from actually implemented forms.

In the meantime, each element expressed below is an example for implementing the present invention. Accordingly, in another implementation of the present invention, another element may be used without departing from the spirit and the scope of the present invention.

Further, an expression “including elements” is an open expression, and simply indicates that corresponding elements exist, and shall not be understood that additional elements are excluded.

Further, expressions, such as “first, second, third, . . . ” are expressions used only for the purpose of discriminating a plurality of elements, and does not limit an order between the elements or other characteristics.

Hereinafter, a photomixer for generating and detecting a terahertz continuous wave according to an exemplary embodiment of the present invention will be described with reference to FIGS. 2 to 4.

Hereinafter, descriptions will be given based on configurations related to the characteristic of the present invention, and descriptions of general configurations and operations will be omitted. Accordingly, a photomixer for generating and detecting a terahertz continuous wave according to an exemplary embodiment of the present invention to be described below may not include only the specified configuration, but may include various additional configurations and detailed configuration within the scope, which is apparent to those skilled in the art, even though specific descriptions thereof are omitted.

Referring to FIGS. 2 to 4, a photomixer for generating and detecting a terahertz continuous wave according to an exemplary embodiment of the present invention may include an optical conductor 100 to which beating light is incident, a plurality of antenna feeding electrodes 200 formed on both side surfaces of the optical conductor, and receiving a terahertz frequency current, and a waveguide 300 for making beating light be incident to the optical conductor.

The optical conductor 100 is a configuration for generating a current having a terahertz frequency based on the incident beating light.

The optical conductor 100 may be implemented by a Low Temperature Grown (LTG) semiconductor, and particularly, an LTG III-V group compound semiconductor. For example, the optical conductor 100 may be implemented by InGaAs, GaAs, and InGaAs/InAlAs. The reason is that the LTG semiconductor has a characteristic of a short carrier lifetime compared to an impurity added at a low temperature (particularly, the LTG semiconductor has a characteristic in that a carrier generated by the incident beating light dissipates before next beating light is incident because of a carrier lifetime of 1 ps or shorter). Accordingly, the optical conductor 100 may be implemented by the LTG semiconductor, thereby serving as a switch generating an AC current having a terahertz frequency.

Further, the optical conductor 100 may be formed in a form of a semiconductor layer formed on a substrate 400. For example, the optical conductor 100 may be formed in a form of an LTG semiconductor layer formed on the substrate 400 as illustrated in FIG. 2 or 3. In this case, the LTG semiconductor layer may be formed to have a height from the substrate 400 having a larger value than that of a width between both side surfaces (both side surfaces on which the antenna feeding electrodes 200 are formed). That is, the LTG semiconductor layer may be formed in a form in which the width between both side surfaces (both side surfaces on which the antenna feeding electrodes 200 are formed) is very small, and the LTG semiconductor layer may be formed in a shape of a plane vertical to the substrate 400 as illustrated in FIG. 2 or 3. Further, the LTG semiconductor layer may be formed to have the width between both side surfaces (both side surfaces on which the antenna feeding electrodes 200 are formed) of 1 μm or smaller. When the LTG semiconductor layer is formed in the aforementioned structures, a uniform electric field may be formed in an entire region of the LTG semiconductor layer, and heat generated inside the optical conductor 100 may be efficiently discharged to the outside.

Further, the optical conductor 100 may receive beating light through the structure of the waveguide 300. For example, the optical conductor 100 may receive the beating light through the structure of the waveguide 300 formed on the substrate 400 through a re-growing process (when the optical conductor 100 is formed of the localized LTG semiconductor layer on the substrate 400, the optical conductor 100 is formed in a form in that the width between both side surfaces is small (1 μm or smaller), and the optical conductor 100 is formed in a form surrounded by the plurality of antenna feeding electrodes 200 dispose at both side surfaces, an electrical or thermal property of the entire photomixer is improved, but there is a problem in that incident efficiency of the beating light deteriorates, and in this respect, the present invention may solve the problem through the structure of the waveguide 300 formed by the re-growing process).

The plurality of antenna feeding electrodes 200 is formed on both side surfaces of the optical conductor 100, and serves to receive a current of a terahertz frequency. The plurality of antenna feeding electrodes 200 may transmit the received current to an antenna device 210, and the antenna device 210 emits a terahertz continuous wave through the operation.

Particularly, the plurality of antenna feeding electrodes 200 may be formed in a form vertical to the substrate 400. Particularly, the plurality of antenna feeding electrodes 200 may be formed in a plane shape vertical to the substrate 400 as illustrated in FIG. 2 or 3, and may be formed in a form that is in large-area contact with both side surfaces of the optical conductor 100 (both side surfaces of the optical conductor 100 with a small width therebetween). Accordingly, the plurality of antenna feeding electrodes 200 may enable a uniform electrical field to be generated inside the LTG semiconductor layer, and absorb heat generated in the entire region of the LTG semiconductor layer through the aforementioned structure.

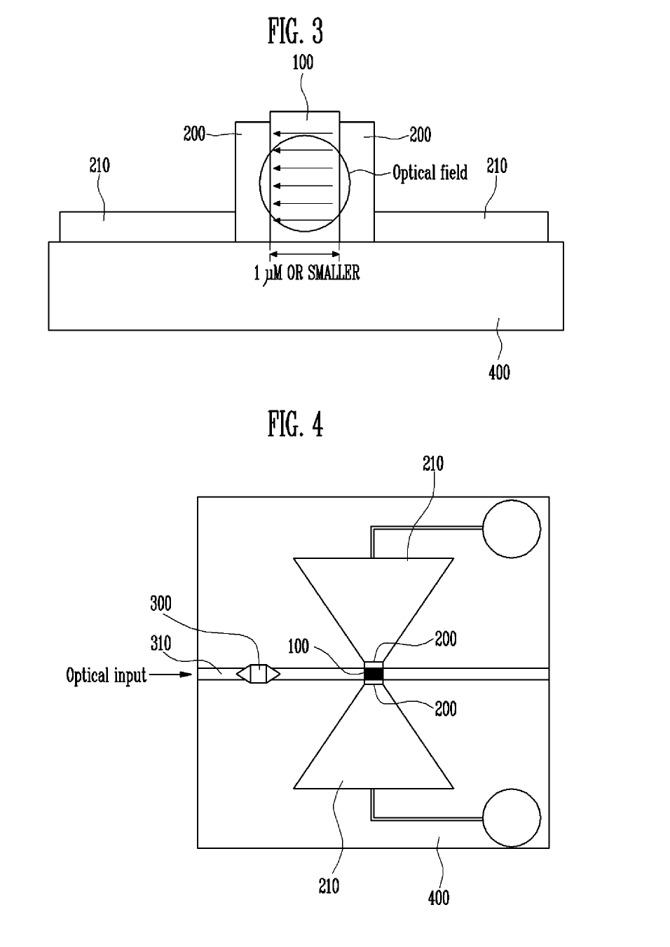

In the meantime, a plurality of antenna devices 210 for emitting a terahertz continuous wave is connected with the plurality of antenna feeding electrodes 200, and in this case, the plurality of antenna devices 210 does not need to be vertically formed with respect to the substrate 400 like the plurality of antenna feeding electrodes 200. That is, the plurality of antenna devices 210 may be formed that is parallel to the substrate 400 and vertical to the plurality of antenna feeding electrodes 200 as illustrated in FIG. 2 or 4.

The waveguide 300 is a configuration for making the beating light be efficiently incident to the optical conductor 100. The waveguide 300 may be connected with a side surface, on which the antenna feeding electrode 200 is not formed, among the side surfaces of the optical conductor 100 as illustrated in FIG. 2 or 3, and may make the beating light be efficiently incident to the optical conductor 100 through the side surface through the aforementioned structure.

Further, the waveguide 300 may also be formed on the substrate 400, and more preferably, after the optical conductor 100 is formed in a localized form by etching, and the like, the waveguide 300 may also be formed on the substrate 400 through the re-growing process.

In the meantime, the waveguide 300 may be connected with a plurality of laser light sources for generating beating light of a terahertz frequency, and may receive beating light generated by the plurality of laser light sources and transmit the received beating light to the optical conductor 100. Here, the plurality of laser light sources may be formed of various laser light sources, and preferably, a distributed FeedBack Laser Diode (DFB LD).

Further, the waveguide 300 may be connected with a functional device 310, and may be implemented in a form enabling beating light passing through the function device 310 to be incident to the optical conductor 100. For example, the waveguide 300 may also be implemented in a form connected with EA modulation, MZ modulation, and the like as illustrated in FIG. 4, and may be implemented in a form enabling beating light passing through the EA modulation, the MZ modulation, and the like to be incident to the optical conductor 100.

The photomixer for generating and detecting the terahertz continuous wave according to the exemplary embodiment of the present invention may generate a uniform electrical field in the entire region of the LTG semiconductor layer (see FIG. 3), and efficiently remove heat generated inside the LTG semiconductor layer through “a structural characteristic in that the LTG semiconductor layer (optical conductor) is formed in a localized form on the substrate, and is formed to have the small width (1 μm or smaller) between both side surfaces (both side surfaces on which the antenna feeding electrodes are formed) of the LTG semiconductor layer”, “a structural characteristic in that the plurality of antenna feeding electrodes is formed on both sides surfaces of the LTG semiconductor layer, and the plurality of antenna feeding electrodes is formed in a form vertical to the substrate”, and “a structural characteristic in that the LTG semiconductor layer and the plurality of feeding electrodes are formed in a plane form that is vertical to the substrate”. Accordingly, the photomixer for generating and detecting the terahertz continuous wave according to the exemplary embodiment of the present invention may make a speed of the carrier be uniform inside the LTG semiconductor layer, decrease a dark current, and thus improve efficiency of the photomixer.

Further, the photomixer for generating and detecting the terahertz continuous wave may enable the beating light to be efficiently incident in a direction of the side surface of the LTG semiconductor layer by using the waveguide structure even in a state where an incident area is decreased by the aforementioned structures, thereby further improving operation efficiency of the photomixer.

Hereinafter, a method of manufacturing the photomixer for generating and detecting the terahertz continuous wave according to an exemplary embodiment of the present invention will be described.

The method of manufacturing the photomixer for generating and detecting the terahertz continuous wave according to the exemplary embodiment of the present invention may include forming an optical conductor layer, to which terahertz beating light is incident, on a substrate (a first operation). Here, the optical conductor layer may be formed by LTG.

After the first operation, the optical conductor layer may be etched and formed in a localized form (a second operation). For example, the optical conductor layer may be formed in a localized form through etching as illustrated in FIG. 2.

After the second operation, a waveguide layer for making the beating light be incident to the localized optical conductor layer may be formed (a third operation). Here, the waveguide layer may be formed by a re-growing process, and may be formed in a form of a passive waveguide.

After the third operation, a plurality of antenna feeding electrodes for receiving a current of a terahertz frequency may be formed on both side surfaces of the optical conductor layer (a fourth operation). Here, the plurality of antenna feeding electrodes may be formed in a form that is vertical to the substrate.

The aforementioned method of manufacturing the photomixer for generating and detecting the terahertz continuous wave according to the exemplary embodiment of the present invention has a different category from, but substantially includes the same technical characteristic as that of the photomixer for generating and detecting the terahertz continuous wave according to the exemplary embodiment of the present invention. Accordingly, the method of manufacturing the photomixer for generating and detecting the terahertz continuous wave according to the exemplary embodiment of the present invention will not described in detail in order to prevent overlapping description, but the aforementioned characteristics related to the photomixer for generating and detecting the terahertz continuous wave according to the exemplary embodiment of the present invention may also be analogically applied to the method of manufacturing the photomixer for generating and detecting the terahertz continuous wave according to the exemplary embodiment of the present invention as a matter of course.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. A photomixer for generating and detecting a terahertz continuous wave, comprising:
an optical conductor to which beating light is incident; and
a plurality of antenna feeding electrodes formed on both side surfaces of the optical conductor, and configured to receive a current of a terahertz frequency.

2. The photomixer of claim 1, wherein the optical conductor is a low temperature grown semiconductor layer formed on a substrate.

3. The photomixer of claim 2, wherein the low temperature grown semiconductor layer has a width between both side surfaces of 1 μm or smaller.

4. The photomixer of claim 2, wherein the beating light is incident to the low temperature grown semiconductor layer through a waveguide structure.

5. The photomixer of claim 2, wherein the plurality of antenna feeding electrodes is formed in a form that is vertical to the substrate.

6. The photomixer of claim 1, wherein a uniform electric field is formed inside the optical conductor.

7. A method of manufacturing a photomixer for generating and detecting a terahertz continuous wave, comprising:
forming an optical conductor layer, to which terahertz beating light is incident, on a substrate; and
forming a plurality of antenna feeding electrodes, which receives a current of a terahertz frequency, on both side surfaces of the optical conductor.

8. The method of claim 7, further comprising:
after the forming of the optical conductor layer, to which the terahertz beating light is incident,
etching the optical conductor layer; and
forming a waveguide layer for incidence of the beating light by a re-growing process after the optical conductor layer is etched.

9. The method of claim 7, wherein in the forming of the plurality of antenna feeding electrodes, which receives the current of the terahertz frequency, the plurality of antenna feeding electrodes is formed in a form that is vertical to the substrate.
